(19) United States
(12) Patent Application Publication
(10) Pub. No.: US 2005/0158136 A1
(43) Pub. Date: Jul. 21, 2005

(54) Cutting method and cutting apparatus for layered sheet, layered sheet, optical element and image display

(75) Inventors: Kazuhiro Higashio, Osaka (JP); Hironori Motomura, Osaka (JP); Minoru Kanatani, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/033,810

(22) Filed: Jan. 13, 2005

(30) Foreign Application Priority Data
Jan. 15, 2004 (JP) 2004-8140

(51) Int. Cl. B23C 1/00; B23D 1/00

(52) U.S. Cl. 409/293; 409/303; 409/203

(57) ABSTRACT

A cutting method and a cutting apparatus which allow a cross section of a layered sheet to be cut with high precision in a manner where the condition of this cross section is excellent and ripping does not easily occur along the expansion direction as well as a layered sheet and an optical member which have been cut according to this method, an optical element provided with this optical member and an image display on which this optical member or this optical element has been mounted are provided.

### BACKGROUND OF THE INVENTION

1. Field of the Invention

The present invention relates to: a cutting method and a cutting apparatus for a layered sheet; a layered sheet that has been cut according to this method; an optical element provided with this layered sheet; and an image display on which this layered sheet or this optical element has been mounted, and is particularly useful in the case where a polarizing plate is used as a layered sheet.

2. Description of the Related Art

Polarizing plates are widely used as components of liquid crystal display (hereinafter may be referred to by the abbreviation LCD) and the demand thereof has dramatically increased in recent years. In addition, the utilization of polarizing plates having a high added value provided with an optical compensation function, a brightness increasing function and the like, has also increased and a request for high quality displays tends to increase even more. A polarizing film made of a polyvinyl alcohol based film into which iodine or dichromatic dye is absorbed and oriented and on which the two sides, protective films made of triacetyl cellulose or the like, are layered is generally utilized as a polarizing plate. In addition, a polarizing film on which a film that has an optical compensation function or a brightness increasing function is layered via an adhesive or an adhesive material is also utilized in accordance with the purpose.

In order to mount such a polarizing plate on an LCD panel, it is necessary to process the polarizing plate into a predetermined form having predetermined dimensions. In general, a die-stamping blade or the like is used to cutout rectangular forms from an original roll of a long layered sheet (which may be referred to as a layered film when formed of, for example, an optical film layer and an adhesive layer). This layered sheet has been expanded in one or two axis directions and cutting may be carried out irrelevant of these expansion directions in accordance with a predetermined purpose. However, fragments in fiber form (whisker form) may appear on the surface of the cross section of the layered sheet that has been cut. In addition, in the case where an adhesive layer is included, some adhesive may protrude due to the pressure at the time of cutting. It is necessary to remove such fragments that have appeared and such protrusions of the adhesive because they may cause deterioration in the quality during the subsequent processes.

Therefore, a method for cutting an anisotropic film that is disclosed in Japanese Unexamined Patent Publication No. S61(1986)-136746 has been proposed according to the prior art.

According to this disclosed method, a process is carried out on the cross sections along the expansion axis of a film that has anisotropic properties and after that, the processed cross sections are cut using a flat blade or a rotary blade in the form of a plane blade.

However, the film may have a large rip along the expansion direction at the time of cutting according to the prior art disclosed in Japanese Unexamined Patent Publication No. S61(1986)-136746, which becomes a problem due to poor appearance. In addition, in recent years LCD panels tend to have narrow frames according to the specification, and the requirements of the precision in the dimensions of the polarizing plates to be mounted on the panels, and of the appearance of the end portions of the polarizing plates have become stricter and stricter. In such a situation, the prior art disclosed in Japanese Unexamined Patent Publication No. S61(1986)-136746 is found to be insufficient in finishing the cross sections with high precision and in excellent condition.

The present invention is provided in view of the above described situation and an object of the invention is to provide a cutting method and a cutting apparatus which allow a layered sheet to be cut with cross sections with high precision and in a good condition, and prevents the layered sheet that has been cut from being easily ripped along the expansion direction, as well as to provide a layered sheet and an optical member that have been cut according to this method, an optical element provided with this optical member and an image display on which this optical member or this optical element is mounted.

### SUMMARY OF THE INVENTION

In order to achieve the above described object, a cutting method for a layered sheet according to the present invention is a cutting method for cutting a cross section of a layered sheet that has been cut into rectangular form and is provided with: the step of forming a body to be cut by stacking a number of layered sheets; the step of rotating a cutting member, which has a rotational axis perpendicular to the cross sections of the above described body to be cut and a cutting blade which is provided so as to protrude toward the cross section side of the above described body to be cut, around the above described rotational axis; and the step of shifting the above described body to be cut relative to the above described cutting member so that the above described cutting blade makes contact with the cross section of the above described body to be cut.

According to the above described cutting method, the cutting blade makes contact with a cross section of the body to be cut while rotating and therefore, fragments that have appeared on this cross section and adhesive protrusions can be removed. At this time, the cutting member has a rotational axis perpendicular to the cross section of the body to be cut and the cutting blade is provided so as to protrude toward the cross section side of the body to be cut and therefore, the cutting blade makes contact with the layered sheets in the direction of the thickness of the layered sheets. As a result of this, ripping does not easily occur along the expansion direction of the layered sheets at the time of the cutting and the occurrence of the deformation and chipping of the material is restricted and therefore, the occurrence of poor appearance can be avoided gaining a cross section in a good condition. Furthermore, a number of layered sheets are stacked when being cut and therefore, the efficiency of cutting can be increased. Here, according to the present invention, “shifting the body to be cut relative to the cutting member” is not limited to “fixing the cutting member while shifting the body to be cut,” but rather, the body to be cut may be fixed while the cutting member is shifted or both the body to be cut and the cutting member may be shifted.

In the above description, it is preferable for the above described cutting blade to be placed perpendicular to the above described cross section.

In the above described configuration, the cutting blade makes contact with the layered sheets effectively in the direction of the thickness of the layered sheets and therefore, the above described working effects can be properly gained. That is to say, a cross section in a good condition can be gained by suppressing, ripping and deforming at the time of cutting and highly precise dimensions can be effectively gained.

In the above description, it is preferable to provide at least a pair of cutting members, each of which is the same as the above described cutting member, placed at a predetermined interval so as to respectively correspond to the cross sections of the above described body to be cut that are opposite to each other and to shift the above described body to be cut relative to the above described cutting members so that the above described cutting blade makes contact with the respective cross sections of the above described body to be cut that are opposite to each other.

As a result of this, the cross sections of the layered sheets that are opposite to each other can be simultaneously cut so as to further increase the cutting efficiency. In addition, the cutting margins of the layered sheets can be easily adjusted by appropriately setting the distance between the cutting members and thereby, layered sheets having desired dimensions can be gained with high precision.

In the above description, it is preferable to provide after the step of cutting the cross sections of the above described body to be cut that are opposite to each other: the step of shifting the above described cutting members in the axis direction of the above described rotational axis so as to be placed at a predetermined interval; the step of rotating the above described body to be cut or the above described cutting members; and the step of shifting the above described body to cut relative to the above described cutting members so that the above described cutting blades can make contact with cross sections which are perpendicular to the cross sections on which the above described cutting has been carried out.

In the above described configuration, after the cross sections of the layered sheets that are opposite to each other have been cut, the body to be cut or the cutting members are rotated and then the cross sections that have not yet been cut (cross sections perpendicular to the cross sections on which the cutting has been carried out) can be cut sequentially. Accordingly, all the cross sections of the layered sheets can be cut more efficiently without the necessity for changing the stage or the like. In addition, the step of shifting the cutting members in the axis direction of the rotational axis so as to place the cutting members at a predetermined interval is provided and thereby, the interval between the cutting blades can be appropriately adjusted so that the cross sections that have not yet been cut can be properly cut even in the case where the body to be cut is made up of the layered sheets that have been cut into a rectangular shape.

In the above description, it is preferable for the rotational speed of the above described cutting member to be 800 rpm to 11000 rpm.

In the above described configuration, a cross-section of a layered sheet can be cut with high precision, and this cross-section can be maintained in an excellent condition. That is to say, in the case where the rotational speed of the cutting member is less than 800 rpm, the cutting ability tends to be lowered, leaving the cross-section coarse. On the other hand, in the case of the rotational speed exceeding 11000 rpm, the cross-section of the layered sheet tends to emit excessive heat, and is fused or deformed.

In the above description, it is preferable for the speed of shifting the above described body to be cut relative to the cutting member to be 10 mm/minute to 15000 mm/minute.

In the above described configuration, a cross-section of a layered sheet can be cut with high precision, and this cross-section can be maintained in an excellent condition. That is to say, in the case where the speed of shifting the body to be cut relative to the cutting member is less than 10 mm/minute, the period of time for cutting becomes too long, making the layered sheet emit excessive heat, and there is a risk of it being fused or deformed. On the other hand, in the case where the speed exceeds 15000 mm/minute, the period of time for cutting tends to be too short, leaving the cross-section coarse.

In addition, in order to achieve the above described object, a cutting apparatus for a layered sheet according to the present invention is a cutting apparatus for cutting a cross section of a layered sheet that has been cut into rectangular form and is provided with: a clamp mechanism for fixing a body to be cut that is formed by stacking a number of layered sheets; a cutting member having a rotational axis perpendicular to the cross sections of the above described body to be cut and a cutting blade that is provided so as to protrude toward the cross section side of the above described body to be cut; a first drive mechanism for rotating the above described cutting member around the above described rotational axis; a second drive mechanism for shifting the above described body to be cut relative to the above described cutting member; and a control unit for controlling the drive functions of the above described first drive mechanism and the above described second drive mechanism.

As a result of this, the above described working effects can be appropriately gained. That is to say, cutting can be efficiently carried out without fail in a manner where the condition of the cross section of the layered sheet after the cutting is excellent and ripping does not easily occur along the expansion direction and in addition, precision in the dimensions of the gained layered sheet can be properly enhanced.

### BRIEF DESCRIPTION OF THE DRAWINGS

FIG. 1 is a perspective diagram for conceptually describing an example of a cutting method according to the present invention;

FIGS. 2(a) and 2(b) are a frontal diagram and a plan diagram for conceptually describing the example of a cutting method according to the present invention;

FIG. 3 is a conceptual diagram showing an example of a cutting apparatus according to the present invention;

FIGS. 4(a) to 4(d) are diagrams for describing a cutting method according to the present invention; and

FIG. 5 is a plan diagram for describing a cutting system in Comparison example 5.

### DESCRIPTION OF THE PREFERRED EMBODIMENTS

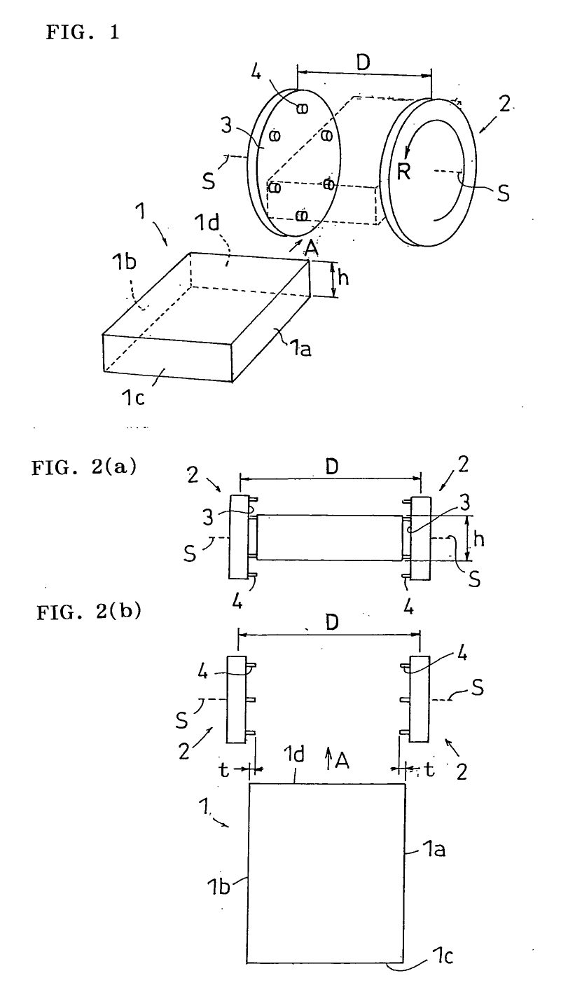

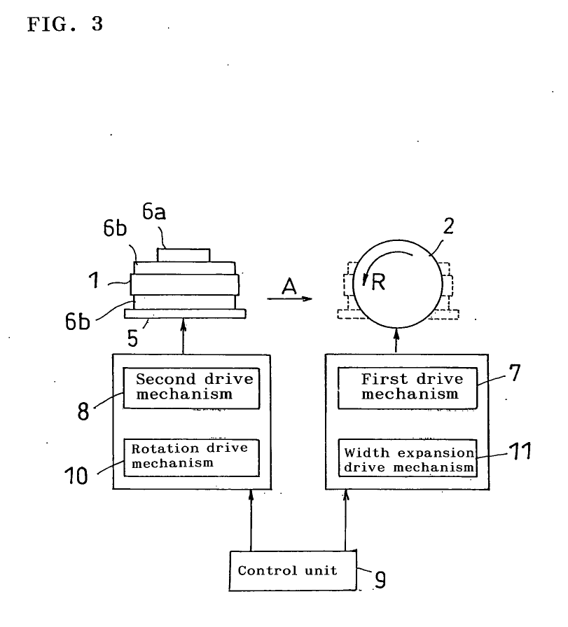

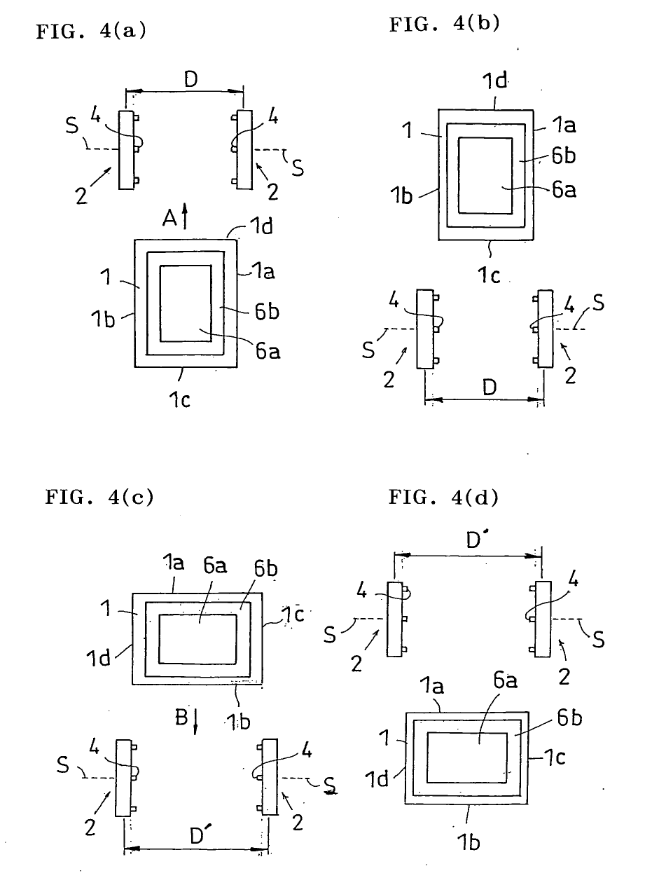

The preferred embodiments of the present invention will be described in reference to the drawings. FIG. 1 is a perspective diagram for conceptually describing an embodiment of a cutting method according to the present invention, and FIG. 2(a) is a frontal diagram and FIG. 2(b) is a plan diagram of the example. FIG. 3 is a conceptual diagram showing an example of a cutting apparatus according to the present invention. FIG. 4 is a plan diagram for describing a cutting method according to the present invention.

<Cutting Method and Cutting Apparatus>

A body to be cut 1 shown in FIG. 1 is gained by fixing the state where a number of layered sheets which have been cut in rectangular form are stacked in the direction of the thickness, and has a cubic or rectangular parallelepiped form. The above described layered sheets are described concretely below. Body to be cut 1 is cut by punching out an original roll of a long layered sheet, and has cross-sections 1a and 1b which are opposite to each other, and cross sections 1c and 1d which are perpendicular to these.

Cutting member 2 has a rotational axis S which is perpendicular to cross-sections 1a and 1b, and is formed to be rotatable in the R direction around rotational axis S by means of the below described first drive mechanism 7. Rotational discs 3 are placed parallel to cross-sections 1a and 1b of body to be cut 1, and have a circular form when viewed from the side, of which the diameter is designed to have a length that exceeds the thickness h of body to be cut 1. Cutting blades 4 are provided so as to protrude in the axis direction of rotational axis S, and are placed at predetermined intervals in flat surface portions of rotational disks 3. In FIG. 1, a pair of cutting members 2 is placed at a predetermined interval D so that the flat surface portions having cutting blades 4 face each other, and thereby, respective cutting blades 4 correspond to cross-sections 1a and 1b. Distance D between cutting members 2 is set in a manner where body to be cut 1 can be moved in between these, and cutting blades 4 are allowed to cut predetermined cutting margins t.

Here, cutting members 2 are not limited to those which are circular when viewed from the side, but rather, may have other forms. In addition, the number of cutting blades 4 that correspond to one cross-section is not particularly limited, but rather may be appropriately determined based on a variety of conditions, such as the distance between the rotational axis S and cutting blades 4. For example, it is preferable for the number of cutting blades 4 to be greater as the distance between rotational axis S and cutting blades 4 increases. At this time, though the arrangement of cutting blades 4 is also not particularly limited, it is preferable for a number of cutting blades 4 to be provided at predetermined intervals having the same distance from rotational axis S, from the point of view of processing efficiency and the like. Concretely speaking, in the case where a cutting region is formed by placing cutting blades 4 at predetermined intervals around rotational axis S so that the distance between the cutting blades and the center of the rotational axis are in a range of 50 mm to 400 mm, it is preferable for cutting blades 4 to have the same distance from rotational axis S, and to be placed at intervals of 15 mm to 1000 mm around the rotational axis, and it is more preferable for the cutting blades to be placed at intervals of 25 mm to 500 mm. As for the number of cutting blades 4 at this time, three to twenty is preferable, and four to ten is more preferable. Furthermore, concerning the circular movement of cutting blades 4 which follows the rotation of cutting member 2, it is preferable for cutting blades 4 to be provided so that the diameter of the circle drawn by the movement exceeds thickness h of body to be cut 1. As a result of this, cutting blades 4 make contact with the entire cross-section in the direction of the thickness of the layered sheets at the time of the below described cutting, and therefore, a cross-section can be appropriately gained in an excellent condition.

The form of cutting blades 4 is not particularly limited, but rather, may be, for example, a prism form, a columnar form having a trapezoidal cross-section, a hemispherical form or the like, in addition to a column form as that shown in FIGS. 1 and 2. The form and the size of cutting blades 4 can be appropriately set on the basis of the dimensions of body to be cut 1, the required processing efficiency and the like. In addition, though it is preferable for cutting blades 4 to be placed in the direction parallel to rotational axis S, that is to say, perpendicularly to cross-sections 1a and 1b, the direction of cutting blades 4 is not limited to this, but rather may be inclined at an appropriate angle, as long as the cutting blades are provided so as to protrude toward the cross-section side of body to be cut 1. Here, though cutting blades made of a metal or diamond can be cited as cutting blades 4, the material of cutting blades 4 is not limited to these, as long as the material is appropriate for cutting body to be cut 1.

The cutting apparatus shown in FIG. 3 is provided with the above described cutting member 2 and a first drive mechanism 7 for rotating cutting member 2, and furthermore, is provided with a support 5 on which body to be cut 1 is placed, and a second drive mechanism 8 that is formed so as to make support 5 reciprocally movable in the direction A toward the cutting member. Body to be cut 1 is placed on support 5 in the condition of being sandwiched by jig plates 6b made of acrylic plates or the like from above and from below, and a clamp plate 6a (which corresponds to the above described clamp mechanism) makes contact with body to be cut 1 from above, in the configuration. As a result of this, body to be cut 1 in the fixed condition is moved in between cutting members 2 so that cutting can be stably carried out. First drive mechanism 7 and second drive mechanism 8 are controlled by a control unit 9 so that cutting can be carried out efficiently and without fail.

Furthermore, the cutting apparatus is provided with a width expansion drive mechanism 11 for shifting cutting members 2 in the axial direction of rotational axis S, and a rotation drive mechanism 10 for rotating support 5, wherein width expansion drive mechanism 11 and rotation drive mechanism 10 are controlled by control unit 9. Accordingly, distance D between cutting members 2 can be adjusted by width expansion drive mechanism 11, and body to be cut 1 that has been placed on support 1 can be rotated by rotation drive mechanism 10.

It is preferable for a soft material to be placed in regions where jig plates 6b make contact with body to be cut 1. At the time when body to be cut 1 is clamped, these regions of jig plates 6b make contact with the top surface of the top layered sheet of body to be cut 1 and with the bottom surface of the bottom layered sheet for the application of the clamp force, and therefore, damage of the layered sheet can be prevented by providing these regions with a soft material. Alternatively, sheets for preventing damage of the layered sheets due to the clamp force may be placed on the upper and lower surfaces of body to be cut 1. Sheets made of, for example, polystyrene, can be cited as these sheets. Furthermore, it is preferable for body to be cut 1 to be formed by stacking layered sheets so that the total thickness thereof is at least 1 mm or greater, preferably 2 mm or greater, in order to prevent damage to the layered sheets due to the clamp force. In the case where the thickness of the stacked layered sheets alone is insufficient, it is preferable to secure a sufficient thickness by additionally stacking sheets made of polystyrene, as described above. In addition, it is preferable for thickness h (mm) and cutting margins t (mm) of body to be cut 1 to be set at values of which the product (h×t) is not greater than 1000. As a result of this, the load of cutting members 2 can be reduced, and precision in the dimensions can be enhanced.

When cutting is carried out, first, a number of layered sheets are stacked to form body to be cut 1, which is placed on support 5 in the condition of being sandwiched by jig plates 6b from above and from below. Then, clamp plate 6a is made to make contact from above with body to be cut 1, which is then fixed. Subsequently, as shown in FIG. 4(a), the pair of cutting members 2 is rotated by first drive mechanism 7, and at the same time, support 5 is shifted in the direction A toward the cutting members by second drive mechanism 8, and thereby, body to be cut 1 is moved in between cutting members 2. Cutting blades 4 of cutting members 2 are made to make contact with cross-sections 1a and 1b of body to be cut 1 that has been moved in, in the direction of the thickness of the layered sheets. FIG. 4(b) shows body to be cut 1 that has passed through between cutting members 2, wherein the condition has been gained where cutting has been carried out on cross sections 1a and 1b.

Next, Cutting members 2 are shifted in the axial direction of rotational axis S by width expansion drive mechanism 11 so as to adjust distance d between cutting members 2, and at the same time, support 5 is rotated by 90 degrees by rotation drive mechanism 10 so as to rotate body to be cut 1. At this time, as shown in FIG. 4(c), distance D between cutting members 2 after adjustment is set in a manner where cutting blades 4 of each cutting member 2 correspond to cross-sections 1c or 1d of body to be cut 1 after being rotated. Here, in the case where body to be cut 1 is in square form when viewed from the top, it is not necessary to adjust distance D between cutting members 2. In addition, body to be cut 1 is rotated to change the cross-sections which correspond to cutting members 2, and the direction of the rotation is not limited to the horizontal direction. As shown in FIG. 4(c), cross-sections 1c and 1d, which have not yet been cut, perpendicular to cross sections 1a and 1b, which have been cut, are placed parallel to rotational discs 3 of cutting members 2. As a result of this, in the same manner as the above described cutting, support 5 is shifted in the direction B toward the cutting members by second drive mechanism 8 while rotating cutting members 2, and thereby, cutting can be carried out on cross-sections 1c and 1d. FIG. 4(d) shows body to be cut 1 that has again passed through between cutting members 2, wherein the condition is gained where cutting has been carried out on all of cross-sections 1a to 1d.

As for the rotational speed of cutting members 2, 800 rpm to 11000 rpm is preferable, 1000 rpm to 10000 rpm is more preferable, and 2000 rpm to 7000 rpm is most preferable. In the case of less than 800 rpm, the cutting ability is lowered, leaving the cross-section coarse, and therefore, in the case where a polarizing plate that has been cut according to this method is mounted on an LCD panel, for example, there is a risk that defects may occur in the display. In addition, in the case where the rotational speed exceeds 11000 rpm, the cross-section of a layered sheet emits excessive heat, and in some cases, is fused or deformed.

As for the speed of shifting of support 5 at the time of cutting, 10 mm/minute to 15000 mm/minute is preferable, and 10 mm/minute to 10000 mm/minute is more preferable. In the case of less than 10 mm per minute, the period of time for cutting becomes too long and the layered sheet emits excessive heat, causing a risk that the layered sheet may be fused or deformed. In addition, in the case where the speed exceeds 15000 mm/minute, the period of time for cutting becomes too short, causing a disadvantage where the cut surface becomes coarse.

<Concrete Examples of Layered Sheets>

As for the layered sheets, sheets gained by layering a variety of members with an adhesive or an adhesive material can be utilized without particular limitations, and application of the present invention to optical members is appropriate. As for the above described optical members, polarizing plates can be cited wherein transparent protective layers are layered on one or both sides of polarizing films using an adhesive or an adhesive material.

As for the above described polarizing films, a variety of films that have been prepared by coloring through the absorption of iodine or a dichromatic substance, by cross-linking, by expanding and by drying according to a conventional method can be utilized without particular limitations. As for the variety of films into which a dichromatic substance is absorbed, as described above, for example, hydrophilic polymer films such as polyvinyl alcohol (hereinafter may be referred to by the abbreviation PVA) based films, partially formal polyvinyl alcohol based films, ethylene and vinyl acetate copolymer based partially saponified films, and cellulose based films can be cited, and in addition to these, for example, polyene orientation films such as products resulting from the dehydration processing of polyvinyl alcohol, and products resulting from the dehydrochlorination processing of polyvinyl chloride can also be utilized. From among these, PVA based films are preferable. The thickness of the above described polarizing films is generally in a range from 5 μm to 80 μm, but is not limited to this range.

A polarizing film of a polyvinyl alcohol based film which is colored with iodine and expanded in one axial direction can be fabricated, for example, by submerging polyvinyl alcohol in a solvent of iodine so that the film thereof is colored, and by expanding the film to three to seven times its original length. If necessary, the film can be submerged in a solvent of boric acid or potassium iodide. Furthermore, if necessary, the polyvinyl alcohol based film may be submerged in water so as to be washed before coloring. Stains or a blocking preventing agent on the surface of the polyvinyl alcohol based film can be cleaned by washing the polyvinyl alcohol based film with water, and in addition, the polyvinyl alcohol based film can be swollen so as to gain the effect of prevention of unevenness of coloring. The expansion may be carried out after the coloring with iodine, or may be expanded while coloring, or may be colored with iodine after the expansion. Expansion can be carried out in a solvent of boric acid or potassium iodide, or in water.

Though the above described transparent protective layer is not particularly limited, but rather, a conventional transparent protective film can be utilized, a film having excellent properties, such as high transparency, physical strength, thermal stability, moisture blocking properties, isometrics and the like, is preferable. As concrete examples of the materials for such a transparent protective layer, cellulose based resins such as diacetyl cellulose and triacetyl cellulose, polyester based resins such as polyethylene terephthalate and polyethylene naphthalate, acryl based resins such as polymethyl methacrylate, polystyrene based resins such as polystyrene and acryl nitrile styrene copolymer (AS resin), polycarbonate based resins, polyethylene, polypropylene, cyclic polymer or norbornene based resins, polyolefin based resins such as ethylene propylene copolymers, vinyl chloride based resins, vinylidene chloride based resins, polyamide based resins such as nylon and aromatic polyamide, polyimide based resins, polyether sulfone based resins, polysulfone based resins, polyether ether ketone based resins, polyphenylene sulfide based resins, vinyl alcohol based resins, vinyl butyral based resins, arilate based resins, polyoxymethylene based resins, epoxy based resins, acetate based resins, and transparent resins which are mixtures of the above described polymers and the like can be cited. In addition, thermosetting resins and ultraviolet curing resins such as the above described acryl based resins, urethane based resins, acryl urethane based resins, epoxy based resins and silicone based resins can be cited.

In addition, the above described transparent protective layer may further have an optical compensation function as a transparent protective layer having an optical compensation function in this manner, for example, conventional transparent films wherein coloring that may cause a change in the visible angle based on the phase difference between liquid crystal cells is prevented, and of which the purpose is to expand the viewable angle for high visibility can be utilized. Concretely speaking, for example, a variety of expanded films gained by expanding the above described transparent resins in one axial direction or in two axial directions, orientation films such as liquid crystal polymers, and layered bodies where orientation layers of liquid crystal polymers or the like are placed on transparent bases, can be cited. Among these, the above described orientation films of liquid crystal polymers are preferable, from the point of view of achieving a wide visible angle for high visibility, and in particular, an optical compensation phase difference plate wherein an optical compensating layer that is formed of an inclined orientation layer of a discotic based or nematic based liquid crystal polymer is supported by the above described triacetyl cellulose film or the like. Commercially available products, such as “WV films” made by Fuji Photo Film Corporation, for example, can be cited as the above described optical compensating phase difference plates. Here, two or more layers of the above described phase difference films or film supports may be layered, and thereby, optical properties, such as phase difference, can be controlled in each of the above described optical compensating phase difference plates.

The thickness of the above described transparent protective layer is not particularly limited, but rather, can be appropriately determined in accordance with the phase difference, protective strength and the like, and generally, can be 5 mm or less, preferably 1 mm or less, and more preferably in the range from 1 μm to 500 μm. The above described transparent protective layer can be appropriately formed according to a conventional method, such as, for example, a method for applying any of the above described variety of transparent resins to a polarizing film, or a method for layering a film made of any of the above described transparent resins or any of the above described optical compensating phase difference plates to the above described polarizing film, and commercially available products can also be utilized.

Here, in the case where any of the above described transparent protective layers are provided on the two sides of a polarizing film, transparent protective layers made of the same material may be used for the front and the rear side, or transparent protective layers made of different materials may be used.

Furthermore, hard coating processing, processing for reflection prevention, processing for the purpose of diffusion or anti-glare and the like, for example, may be additionally carried out on any of the above described transparent protective layers. A purpose of the above described hard coat processing is to prevent scratching on the surface of the polarizing plate, and is for forming a hard coating film having a high degree of hardness and smoothness of a curing resin on the surface of any of the above described transparent protective layers. As the above described curing resin, ultraviolet curing resins such as, for example, silicone based resins, urethane based resins, acryl based resins and epoxy based resins can be utilized, and the above described processing can be carried out according to a conventional method. A purpose of the above described processing for reflection prevention is to prevent reflection of external light from the surface of the polarizing plate, and can be carried out by forming a reflection preventing film or the like according to the prior art.

A purpose of the above described processing for anti-glaring is to prevent hampering of the visibility of light that has passed through the polarizing plate caused by the reflection of external light from the surface of the polarizing plate, and this processing can be carried out, for example, by forming microscopic irregular structures on the surface of any of the above described transparent protective layers according to a conventional method. As for such a method for forming an irregular structure, a method for roughening of a surface in accordance with a sandblast method or emboss processing, and a method for forming a transparent protective layer as described above by mixing transparent microscopic particles into a transparent resin as described above, can be cited.

As for the above described transparent microscopic particles, particles of silica, alumina, titania, zilconia, tin oxide, indium oxide, cadmium oxide and antimony oxide, for example, can be cited, and in addition to these, inorganic microscopic particles having conductivity, and organic particles formed of cross-linked or non cross-linked polymer particles can also be utilized. Though the average diameter of the above described transparent microscopic particles is not particularly limited, it is preferable for it to be, for example, in the range from 0.5 μm to 50 μm. In addition, though the ratio of the mixture of the above described transparent microscopic particles is not particularly limited, it is preferable for it to be in the range from 2 weight parts to 70 weight parts per 100 weight parts of the above described transparent resin, and more preferably in the range from 5 weight parts to 50 weight parts.

An anti-glare layer into which transparent microscopic particles have been mixed as described above can be utilized as a transparent protective layer in itself, and in addition, may be formed as a layer that has been applied to the surface of the transparent protective layer. Furthermore, the above described anti-glare layer may also serve as a diffusion layer for diffusing light passing through the polarizing plate, in order to expand the visible angle.

Here, the above described reflection preventing film, diffusion layer, anti-glare layer and the like, for example, can be provided to the polarizing plate separately from the above described transparent protective layer, as in an optical layer formed of a sheet or the like to which these layers have been provided.

Transparent protective layers that have been formed as described above may be layered on only one or both sides of the above described polarizing film, and in the case where transparent protective layers are layered on both sides, transparent protective layers of the same type may be utilized, or transparent protective layers of different types may be utilized.

A method for making the above described polarizing film adhere to the above described transparent protective layer, in particular, the optical compensating phase difference plate, is not particularly limited, but rather, adhesion can be carried out according to a conventional method. In general, an adhesive or an adhesive material is utilized, of which the type can be appropriately determined in accordance with the type of the polarizing film and transparent protective layer. Concretely speaking, in the case where the above described polarizing film is a polyvinyl alcohol based film, a water soluble adhesive is preferable, from the point of view of, for example, stability the adhesion processing. As for the water soluble adhesive, polyvinyl alcohol based adhesives, gelatin based adhesives, vinyl based latexes, water soluble polyurethane and water soluble polyester can be cited as examples. The above described water soluble adhesives are generally used as adhesives made of solutions.

The gel strength of some of the above described adhesives is increased by making them contain a cross-linking agent, thereby increasing adhesiveness. Polyvinyl alcohol based adhesives can be made to contain a water soluble cross linking agent such as boric acid, borax, glutaraldehyde, melamine and oxalic acid. Though the amount of added water soluble cross-linking agent is not particularly limited, the amount is generally set at a value not greater than 40 weight parts relative to 100 weight parts of the solid of polyvinyl alcohol, which is the main component, and is preferably in a range from 0.5 weight parts to 30 weight parts. In addition, pH of the above described adhesives can be changed in order to make cross-linking progress. Furthermore, an additive such as formic acid, phenol, salicylic acid or benzaldehyde can be mixed with the above described adhesives as an antiseptic agent at the time of preparation of the solution, if necessary.

These adhesives may be directly applied to the surface of the polarizing film or the transparent protective layer, or an adhesive layer may be formed of the above described adhesives in such a form as a tape or a sheet, which may be placed on the above described surface.

Adhesion of a polarizing film to a transparent protective layer can be carried out by means of a roll laminator. Though the thickness of the adhesive layer is not particularly limited, it is generally approximately 0.05 μm to 5 μm.

In addition, it is preferable for the polarizing plate to additionally have an adhesive material layer, for example, in order to make lamination on liquid crystal cells and the like easy, as described above, and such adhesive material layers can be placed on one or two sides of the above described polarizing plate. The formation of the above described adhesive material layers on the surfaces of the above described polarizing plates can be carried out, for example, according to a method wherein a solution or melted liquid of an adhesive material is directly applied to predetermined surfaces of the above described polarizing plate so as to form a layer in accordance with a spreading technique, such as flowing or applying, or according to a method wherein an adhesive material layer that has been formed in the above described manner on the below described separator is shifted to predetermined surfaces of the above described polarizing plate. Here, such an adhesive material layer may be formed on either surface of the polarizing plate, and for example, may be formed on the surface of the above described optical compensating phase difference plate that is exposed from the polarizing plate.

In the case where the surface of the adhesive material layer that has been provided to the polarizing plate as described above is exposed, it is preferable to cover the surface with a separator for the purpose of preventing contamination or the like during the time before the above described adhesive material layer is practically used. Such a separator can be formed according to a method wherein an appropriate film, such as the above describe transparent protective films, is provided with a release coating of a release agent such as a silicon based agent, a long chain an alkyl based agent, a fluorine based agent or a molybdenum sulfide, if necessary.

The above described adhesive material layer may be formed of a single layer, or may have a layered body. As the layered body, a layered body where single layers having different compositions or single layers of different types, for example, are combined can be utilized. In addition, in the case where the adhesive material layers are placed on the two sides of the above described polarizing plate, they may be the same adhesive material layers, or may be adhesive material layers having different compositions, or adhesive material layers of different types. The thickness of such adhesive material layers is appropriately determined in accordance with the configuration of the polarizing plate, and is generally 1 μm to 500 μm, preferably 5 μm to 200 μm, and more preferably 10 μm to 100 μm.

The adhesive material that forms the above described adhesive material layers preferably exhibits excellent optical transparency, appropriate wettability, and adhesive properties such as cohesion and adhesion. As for concrete examples, adhesive materials that have been prepared using polymers such as acryl based polymers and silicone based polymers, polyester, polyurethane, polyamide, polyether, and polymers such as fluorine based polymers and rubber based polymers as base polymers can be cited.

The adhesive properties of the above described adhesive material layer can be appropriately controlled, for example, according to a conventional method, by adjusting the degree of cross-linking, the molecular weight and the like on the basis of the composition and the molecular weight of the base polymer that is to form the above described adhesive material layer, the method for cross-linking, the contents of the cross-linking functional group, the ratio of the mixture of the cross-linking agent and the like.

As for the polarizing plate, a polarizing plate on which an additional optical layer is layered, for example, can be utilized for practical use. Though such an optical layer is not particularly limited, optical layers which are used for the formation of a liquid crystal display (which corresponds to the above described image display), such as a reflective plate, a semi-transmittable reflective plate, a phase difference plate including λ plates, a ½ wavelength plate, a ¼ wavelength plate and the like, a view angle compensating film and a brightness increasing film can be cited, as shown in the following. In addition, these optical layers may be of one type, or two or more types may be used together. It is preferable for such optical members to be a reflective type polarizing plate, a semiconductor-transmittable reflective type polarizing plate, an elliptic polarizing plate, a circular polarizing plate, a polarizing plate where a view angle compensating film is layered, or the like. These varieties of polarizing plates are described below.

First, an example of a reflective type polarizing plate and semi-transmittable reflective polarizing plate of the present invention is described. An additional reflective plate is layered on a polarizing plate as described above after heat treatment in the above described reflective type polarizing plate and an additional semi-transmittable reflective plate is layered on a polarizing plate as described above after heat treatment.

The above described reflective type polarizing plate is usually placed on the rear side of a liquid crystal cell, and can be utilized for a liquid crystal display (reflective type liquid crystal display) or the like of a type for the display with incident light from the visible side (display side) being reflected. Such a reflective type polarizing plate has the advantage of making reduction in the thickness of a liquid crystal display possible, because a light source, such as a backlight, does not need to be incorporated, and thus can be omitted.

The above described reflective type polarizing plate can be fabricated according to a conventional method, such as a method for forming a reflective plate of a metal or the like on one side of the above described polarizing plate. Concretely speaking, a reflective type polarizing plate can be cited, wherein a mat process, for example, is carried out on one side (exposed side) of the transparent protective layer in the above described polarizing plate if necessary, and a metal foil or a deposition film is formed of a reflective metal, such as aluminum, on the surface of this side as a reflective plate.

In addition, a reflective type polarizing plate can also be cited, wherein, a reflective plate is formed on a transparent protective layer of which the surface has a microscopic uneven structure that contains microscopic particles in any of a variety transparent resins, as described above, in a manner where the microscopic uneven structure is reflected in the reflective plate. The reflective plate of which the surface has the microscopic uneven structure has the advantage of preventing directivity or glare by, for example, diffusing incident light into irregular reflection, and of suppressing irregular brightness and darkness. Such a reflective plate can be formed directly on an uneven surface of the above described transparent protective layer as a metal foil for a metal deposition film, as described above, according to a conventional method such as a plating method, as well as a deposition method, including a vapor deposition method, an ion plating method and a sputtering method.

In addition, a reflective sheet and the like where a reflective layer is provided on an appropriate film, such as the above described transparent protective film, may be utilized as a reflective plate, in place of the above described reflective plate that is formed directly on the transparent protective layer of the polarizing plate, as described above. The above described reflective layer in the above described reflective plate is usually formed of a metal, and therefore, it is preferable for the reflective surface on the above described reflective layer to be in the condition of being coated with a film, as described above, or a polarizing plate, when being used, in order to prevent reduction in the reflectance due to oxidation, sustain the initial reflectance for a long period of time, and avoid separate formation of a transparent protective layer, for example.

On the other hand, the above described semi-transmittable polarizing plate has a semi-transmittable reflective plate in place of a reflective plate, as in the above described reflective type polarizing plate. A half mirror that reflects light from a reflective layer, and that transmits light can be cited as an example of the above described semi-transmittable reflective plate.

The above described semi-transmittable polarizing plate is normally provided on the rear side of a liquid crystal cell so as to be utilized in a type of liquid crystal display or the like, wherein an image is displayed by reflecting incident light from the visible side (display side) in the case where the liquid crystal display is utilized in a comparatively bright atmosphere, and an image is displayed by utilizing the incorporated light source, such as a backlight, that is incorporated on the back side of the semi-transmittable polarizing plate in a comparatively dark atmosphere. That is to say, the above described semi-transmittable polarizing plate is useful for forming a type of liquid crystal display that allows energy that is utilized for a light source, such as a backlight, to be saved in a bright atmosphere, and that allows the semi-transmittable type polarizing plate to be utilized when using the above described incorporated light source in a comparatively dark atmosphere.

Next, an example of an elliptical polarizing plate and circular polarizing plate is described. An additional phase difference plate or λ plate is layered on a polarizing plate as described above, after heat treatment in the above described polarizing plates.

The above described elliptical polarizing plate can be used effectively in the case where hue (blue or yellow) caused by birefringence of, for example, the liquid crystal layer of a super twist nematic (STN) type liquid crystal display, is compensated for (prevented), so as to gain a black and white display without hue, as described above. Furthermore, an elliptical polarizing plate where the three-dimensional index of refraction is controlled is preferable, because it allows hue caused when the screen of the liquid crystal display is viewed from a diagonal direction to be compensated for (prevented). On the other hand, the above described circular polarizing plate is effective in the case where the color tone of an image, which is displayed in color, of a reflective type liquid crystal display is adjusted and has a function of reflection prevention.

The above described phase difference plate is used in the cases where linear polarization is converted to elliptical polarization or circular polarization, elliptical polarization or circular polarization is converted to linear polarization, or the direction of polarization of linear polarization is converted. In particular, a ¼ wavelength plate (also referred to as λ/4 plate), for example, is used as a phase difference plate that converts linear polarization to elliptical polarization or circular polarization, and that converts elliptical polarization or circular polarization to linear polarization, respectively, and a ½ wavelength plate (also referred to as λ/2 plate) is utilized in the case where the direction of polarization of linear polarization Is converted.

As for the materials of the above described phase difference plates, for example, polyolefins such as polycarbonate, polyvinyl alcohol, polystyrene, polymethyl methacrylate, polypropylene and the like, birefringent film gained by carrying out an expansion process on polymer films such as polyarilate, polyamide, polyimide and polynorbornene, orientation films of liquid crystal polymers, layered bodies where orientation layers of liquid crystal polymers are supported by films and the like can be cited.

As for the types of the above described phase difference plates, for example, a variety of wavelength plates, such as a λ/2 plate, a λ/4 plate and the like, plates having purpose of compensation for hue due to birefringence of liquid crystal layers and compensation of visible angles, such as reduction visible angle expansion, and other plates having phase differences in accordance with purposes of utilization may be involved, in addition to inclination orientation films where the index of refraction in the direction of the thickness is controlled. In addition, layered bodies where two or more types of phase difference plates are layered so that optical properties such as phase differences are controlled may be used.

The above described inclination orientation films can be gained according to a method, for example, for applying an expansion process or a contraction process on polymer films under the working effects of this shrinking force due to the application of heat by making heat shrinkable films adhere to these polymer films, or according to a method for diagonally orienting liquid crystal polymers.

Next, an example of a polymerizing plate on which a visible angle compensating film has been layered is described. The above described visible angle compensating film is a film of which the visible angle has been expanded in a manner where an image of the liquid crystal display can be viewed comparatively clearly, even in the case where the image is seen from a slightly diagonal direction, instead of the direction perpendicular to the image. As for such a visible angle compensating film, for example, a triacetyl cellulose film to which discotic liquid crystal or nematic liquid crystal is applied, or a phase difference plate is used. As for a conventional phase difference plate, for example, a polymer film having birefringence that has expanded in one axis in the direction of this plane is utilized, and as for the above described visible angle compensating film, for example, a phase difference plate, such as a two-direction expanded film, including a polymer film having birefringence that has expanded in two axis directions in the plane, or an inclination oriented polymer film that has been expanded in an axis direction in the plane has also expanded in the direction of the thickness, and of which the index of refraction in the direction of the thickness is controlled, is utilized. As for the above described inclination orientation film, for example, a polymer film to which a heat shrinking film is made to adhere, and to which an expansion process or a contraction process is applied under the working effects of the shrinking force due to the application of heat, a liquid crystal polymer which has been diagonally oriented and the like can be cited. Here, as for the material of the above described polymer film, the same type of polymer materials of the above described phase difference plates, as described above, can be utilized.

Next, an example of a polarizing plate where an additional film for increasing brightness is layered on the above described polarizing plate is described. This polarizing plate is normally utilized by being placed on the rear side of a liquid crystal cell. The above described film for increasing brightness exhibits properties that reflect light resulting from linear polarization in a predetermined polarization axis or circular polarization in a predetermined direction when natural light enters, due to the backlight of the liquid crystal display or due to reflection from the rear side thereof, while allowing other light to transmit. Light from a light source, such as a backlight, is allowed to enter, so as to gain transmitting light in the condition of being polarized in a predetermined manner, while light in the condition other than the above described condition of being polarized in a predetermined manner is reflected without being allowed to transmit. The light that has been reflected from the surface of this film for increasing brightness is inverted via a reflective plate or the like that has been provided on the back side of the film, is made to reenter the film for increasing brightness so that a portion or the entirety of the light is allowed to transmit as light in the condition of being polarized in a predetermined manner, and thereby, an increase in the amount of light that transmits the film for increasing brightness is achieved, and at the same time, polarized light which is difficult to absorb for a polarizing film (polarizer) is supplied so as to achieve an increase in the amount of light that can be utilized for the liquid crystal image display, thus increasing brightness. In the case where light emitted by a backlight or the like enters through a polarizer from the rear side of a liquid crystal cell without utilization of the above described film for increasing brightness, light having a polarization direction that does not agree with the polarization axis of the above described polarizer is mostly absorbed by the above described polarizer, and does not transmit through the above described polarizer. That is to say, approximately 50% of light, the ratio of which may differ, depending on the properties of the utilized polarizer, is absorbed by the above described polarizer, and accordingly, the amount of light that can be utilized for the liquid crystal image display is decreased, leaving the image dark. The above described film for increasing brightness does not allow light having a polarization direction that is absorbed by the polarizer to enter into the above described polarizer, but rather, allows such light to be reflected once from the film for increasing brightness, and in addition, is inverted via the reflective plate that has been provided on the rear side of the film, thus repeating reentrance of light into the above described film for increasing brightness. Therefore, polarized light of which the polarization direction allows the light which is reflected or inverted between the film and the reflective plate to pass through the above described polarizer is transmitted so as to be supplied to the above described polarizer, and therefore, light emitted by the backlight can be efficiently utilized for the display of an image of a liquid crystal display, and the image can be made bright.

The types of the above described film for increasing brightness are not particularly limited, but rather, for example, a film that exhibits properties for allowing light resulting from linear polarization in a predetermined polarization axis to transmit while reflecting other light, such as a multilayered thin film of dielectrics, a multilayered body of thin films having different anisotropies of the index of refraction can be utilized.

Accordingly, a film for increasing brightness of a type for transmitting light resulting from linear polarization of a predetermined polarization axis can efficiently transmit light while suppressing absorption loss by the above described polarizing plate, by allowing the transmission light thereof to enter the polarizing plate when having the same polarization axis. On the other hand, in the case of a film for increasing brightness of a type for transmitting light resulting from circular polarization, such as a cholesteric liquid crystal layer, though the transmission light may be allowed to enter the polarizer without change, it is preferable for the transmitted light resulting from circular polarization to be linearly polarized via a phase difference plate before entering the above described polarizer, from the point of view of suppression of absorption loss. Here, a ¼ wavelength plate is used as the above described phase difference plate, and thereby, circular polarization can be converted to linear polarization.

In many cases, the above described film for increasing brightness exists on the top surface on the backlight side, and therefore, scratches and unevenness may easily be caused at the time handling or at the time of attachment to the panel, and therefore, it is also possible to carry out a process such as a hard coating process on the top surface of the above described film for increasing brightness, in order to prevent such scratches and unevenness. The above described hard coating process is, for example, a process for forming a hard coating film having a high degree of hardness and smoothness of a hard resin on the surface of the above described film for increasing brightness. As for the above described hard resin, for example, ultraviolet curing resins, such as silicon based resins, urethane based resins, acryl based resins and epoxy based resins can be utilized, and the above described process can be carried out according to a conventional method.

Furthermore, the above described film for increasing brightness, in general, is easily charged with static electricity, and therefore, there is a possibility that the orientation of the liquid crystal of the liquid crystal display will be disturbed, thus negatively affecting the display. For the purpose of preventing this, a static electricity prevention function may be added to the above described film for increasing brightness. As for the materials for implementing the above described static electricity prevention function, a static electricity prevention agent such as cationic materials, anionic materials and non-ionic materials, conductive polymers such as polyolefin based polymers and polyaniline polymers, and microscopic particles having conductivity such as alumina, titania, zirconia, tin oxide, indium oxide and antimony oxide can be cited, without particular limitations.

A phase difference plate that functions as a ¼ wavelength plate in a wide wavelength range, such as the visible light range, is gained by, for example, layering a phase difference layer that functions as a ¼ wavelength plate for single color light, such as light having a wavelength of 550 nm, and a phase difference layer showing the phase difference properties (for example, phase difference layer that functions as a ½ wavelength plate). Accordingly, a phase difference plate that is placed between the polarizing plate and the film for increasing brightness may be a layered body formed of one or more phase difference layers. Here, a cholesteric liquid crystal layer can have a layered structure where two or more layers having different reflected wavelengths are combined and layered. As a result of this, a polarizing plate for reflecting light resulting from circular polarization in a wide wavelength range, such as the visible light range, can be gained, and transmission circular polarization in a wide wavelength range can be gained, based on this.

A variety of polarizing plates, as described above, may, for example, be polarizing plates on which two or more optical layers are layered. Concretely speaking, a reflective type elliptical polarizing plate, a semi-transmittable elliptical polarizing plate and the like, which are gained by combining reflective type polarizing plates or semi-transmittable polarizing plates, as described above, and phase different plates can be cited.

As described above, though a polarizing plate on which two or more optical layers have been layered can be formed according to a method for layering sequentially and separately during the manufacturing process for a liquid crystal display or the like, the polarizing plate that has been formed in advance as a combination of layered bodies has the advantage where the stability in the product quality and working efficiency in assembly are excellent for increasing the manufacturing efficiency for a liquid crystal display or the like. Here, a variety of adhesion means, such as an adhesive material layer, can be used in the layers, as described above.

In addition, respective layers, such as polarizing films that form a variety of polarizing plates wherein the above described polarizing plate and optical layers are layered, transparent protective layers, optical layers and adhesive layers may be provided with the ability to absorb ultraviolet rays by appropriately processing these with an ultraviolet absorbing agent, such as, for example, a salicylate based compound, a benzophenone based compound, a benzotriazole based compound, a cyanoacrylate based compound or a nickel complex based compound.

It is preferable for a polarizing plate to be utilized in any of a variety of forms, such as in a liquid crystal display, as described above, and the polarizing plate can be, for example, used in a liquid crystal display of a reflective type, a semi-transmittable type, or a type that is both transmittable and reflective, where the polarizing plate is placed on one or two sides of the liquid crystal cell. The type of the above described liquid crystal cell for forming the liquid crystal display can be arbitrarily selected, and, for example, a thin film transistor type, a single matrix driving type, represented by a super twist nematic type, and various other types of liquid crystal cells can be utilized.

In addition, in the case where a variety of polarizing plates on which a polarizing plate and an optical layer are layered are provided to the screen of a liquid crystal cell, they may be of the same type, or may be different types. Furthermore, at the time of the formation of a liquid crystal display, one or more layers of appropriate parts, such as prism array sheets, lens array sheets, light diffusing plates, backlights and the like can be placed at appropriate positions.

A liquid crystal display where a polarizing plate that has been cut, as described above, is placed on at least one surface of a liquid crystal cell becomes an apparatus having excellent display quality when mounted on a panel, for example, in a small frame mode.

### Other Embodiments

(1) Though in the above described embodiments, examples are shown where body to be cut 1 is moved toward the cutting member side so as to carry out a cutting process, the present invention is not limited to this, but rather, cutting member 2 may be moved in the direction toward body to be cut 1 so as to carry out a cutting process. In addition, body to be cut 1 is not necessarily carried in between a pair of cutting members 2 in a manner as in the above described embodiments, but rather, one cutting member 2 may be utilized for processing, or a plurality of cutting members, each of which is the same as cutting member 2, may be utilized for one cross-section to be processed. Furthermore, cutting members 2 may be moved relative to cross sections in the direction approximately perpendicular to the cross-sections.

(2) Second drive mechanism 8 may work also as rotation drive mechanism 10, or the two may be independent in a cutting apparatus of the present invention. The same can be said for first drive mechanism 7 and width expansion drive mechanism 11. In addition, rotation drive mechanism 10 may rotate cutting members 2 instead of support 5.

(3) Though in the above described embodiments, examples are shown where clamp plate 6a is made to make contact with body to be cut 1 from above in the clamp mechanism, the clamp mechanism according to the present invention is not limited to this.

### EXAMPLES

Next, examples which concretely show the configuration and the effects of the present invention are described. A polarizing plate that is mounted on a liquid crystal display where high levels of processing precision and finishing precision are required is utilized in order to evaluate each of the following items. In this polarizing plate, transparent protective layers are provided on both sides of a polarizing film, a film for increasing linear polarization separated brightness that utilizes multilayer interface reflection is provided on the surface of the transparent protective layer, on one side, via an adhesive layer, and in addition, a protective film for preventing scratches and stains is provided to the surface of this film for increasing brightness. On the other hand, an adhesive layer for making the polarizing plate adhere to a liquid crystal display is formed on the surface of the transparent protective layer, on the other side, and this surface is provided with a liner, for release, that protects the adhesive layer. The examples, comparison examples and the respective evaluation items are described below.

### Examples 1 to 5

Thirty polarizing plates which are the same as the above described polarizing plate and which were cut to 310 mm×235 mm were layered in the direction of the thickness, and were cut to 305 mm×230 mm according to the above described embodiments. The rotation speed of the cutting members and the speed of movement of the support at the time of cutting are shown in Table 1, for each of Examples 1 to 5.

### Comparison Examples 1 to 4

Thirty polarizing plates which are the same as the above described polarizing plate and which were cut to 310 mm×235 mm were layered on top of each other, and were cut to 305 mm×230 mm according to the above described embodiments. The rotation speed of the cutting members and the speed of movement of the support at the time of cutting are shown in Table 2, for each of Comparison examples 1 to 4.

### Comparison Example 5

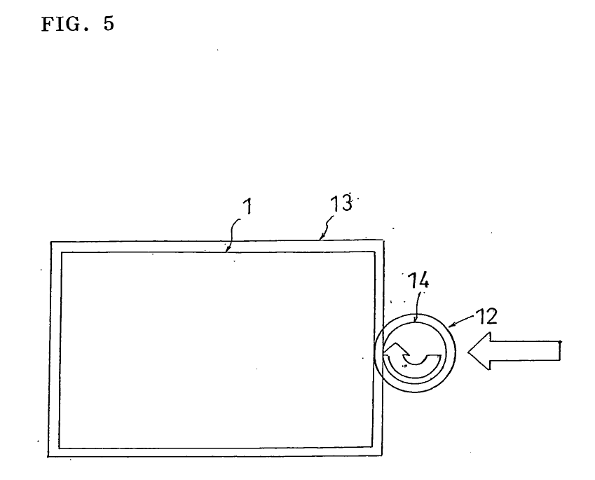

Thirty polarizing plates which are the same as the above described polarizing plate and which were cut to 310 mm×235 mm were layered on top of each other, and were cut to 305 mm×230 mm according to a method of copying the cross-sections of body to be cut 1 using a rotary blade 12 that was provided coaxially with a copying roller 14, which was at all times pressed against a copying die 13, as shown in FIG. 5. Here, the rotation speed of the rotary blade was set at 5000 rpm, and the speed of movement was set at 3000 mm per minute.

### Comparison Example 6

Polarizing plates were cut to 305 mm×230 mm by means of punching processing using a blade die, and no cutting was carried out, as shown in the present invention and in FIG. 4.

Dimension Processing Precision

The standard deviation was calculated by measuring the dimensions after processing of the respective polarizing plates. It indicates that the smaller the number is, the more excellent the processing precision is.

Evaluation of Appearance

The cross sections of the respective polarizing plates after processing were observed using a microscope, and the condition of the cross-sections and the existence of protruding adhesives were evaluated. The results of the evaluation have three levels, from better to worse, in the order OO, Δ, X.

Table 3 shows the results of the evaluation of the above described items in the examples and the comparison examples.

TABLE 1

| | Rotational speed of cutting | Shifting speed of |
|---|---|---|
| | members | support |
| | (revolutions/minute) | (mm/minute) |
| Embodiment 1 | 5000 | 10 |
| Embodiment 2 | 5000 | 500 |
| Embodiment 3 | 5000 | 10000 |
| Embodiment 4 | 1000 | 500 |
| Embodiment 5 | 10000 | 500 |

TABLE 2

| | Rotational speed of | Shifting speed of |
|---|---|---|
| | cutting members | support |
| | (revolutions/minute) | (mm/minute) |
| Comparison example 1 | 5000 | 5 |
| Comparison example 2 | 5000 | 50000 |
| Comparison example 3 | 500 | 500 |
| Comparison example 4 | 20000 | 500 |

TABLE 3

| | | Appearance evaluation | |
|---|---|---|---|
| | Cutting precision | Condition of | Adhesive |
| | in dimensions | cross section | protrusion |
| Embodiment 1 | 0.038 | ◯◯ | ◯◯ |
| Embodiment 2 | 0.038 | ◯◯ | ◯◯ |
| Embodiment 3 | 0.040 | ◯◯ | ◯◯ |
| Embodiment 4 | 0.037 | ◯◯ | ◯◯ |
| Embodiment 5 | 0.040 | ◯◯ | ◯◯ |
| Comparison | 0.036 | X (fused and | X (fused and |
| example 1 | | deformed) | deformed) |
| Comparison | 0.058 | X (unevenness) | Δ (partial |
| example 2 | | | protrusions) |
| Comparison | 0.055 | X (unevenness) | Δ (partial |
| example 3 | | | protrusions) |
| Comparison | 0.035 | X (fused and | X (fused and |
| example 4 | | deformed) | deformed) |
| Comparison | 0.043 | Δ (chipping in | ◯◯ |
| example 5 | | brightness | |
| | | increasing film) | |
| Comparison | 0.045 | Δ (different | Δ (partial |
| example 6 | | levels) | protrusions) |

As shown in Table 3, it can be seen that cutting in Examples 1 to 5 is comparatively excellent in the dimension processing precision. Furthermore, the condition of the cross-sections after processing is good, without any protruding adhesive, thus gaining good results in the evaluation of appearance. On the other hand, in Comparison example 1, the speed of the movement of the support is too slow, making the period of time for cutting too long, and the layered sheets emit excessive amounts of heat, in a manner where the cross sections are fused and deformed. In Comparison example 2, the speed of the movement of the support is too fast, making the period of time for cutting too short, and the cross-sections become too rough, with a low level of dimension processing precision, and at the same time, unevenness and protruding adhesive are found on the cross sections. In Comparison example 3, the rotation speed of the cutting members is too slow, lowering the cutting ability, and the cross-sections become coarse, with a low level of dimension processing precision, and at the same time, unevenness and protruding adhesive are found on the cross-sections. In Comparison example 4, the rotation speed of the cutting members is too fast, causing the layered sheets to emit excessive heat, and the cross-sections are fused and deformed. In Comparison example 5, chips are found in the cross-sections of the films for increasing brightness. The rotary blade makes contact with the layered sheets in the direction perpendicular to the direction of the thickness of the layered sheets according to the cutting method adopted in Comparison example 5, and therefore, it is assumed that ripping along the direction of expansion has occurred. In Comparison example 6, no cutting has been carried out after the punching processing using a blade die, and therefore, the level of the decision processing precision is low, and steps and protruding adhesive are found on the cross-sections.

1. A cutting method for cutting a cross section of a layered sheet that has been cut into rectangular form, comprising:
the step of forming a body to be cut by stacking a number of layered sheets;
the step of rotating a cutting member, which has a rotational axis perpendicular to the cross sections of said body to be cut and a cutting blade which is provided so as to protrude toward the cross section side of said body to be cut, around said rotational axis; and
the step of shifting said body to be cut relative to said cutting member so that said cutting blade makes contact with the cross section of said body to be cut.

2. The cutting method according to claim 1, wherein said cutting blade is placed perpendicular to said cross section.

3. The cutting method according to claim 1, wherein
at least a pair of cutting members, each of which is the same as said cutting member, is provided and placed at a predetermined interval so as to respectively correspond to cross sections of said body to be cut that are opposite to each other, and
said body to be cut is shifted relative to said cutting members so that said cutting blade makes contact with the respective cross sections of said body to be cut that are opposite to each other.

4. The cutting method according to claim 3, comprising after the step of cutting the cross sections of said body to be cut that are opposite to each other:
the step of shifting said cutting members in the axis direction of said rotational axis so as to be placed at a predetermined interval;
the step of rotating said body to be cut or said cutting members; and
the step of shifting said body to cut relative to said cutting members so that said cutting blades can make contact with cross sections which are perpendicular to the cross sections on which said cutting has been carried out.

5. The cutting method according to claim 1, wherein the rotational speed of said cutting member is 800 rpm to 11000 rpm.

6. The cutting method according to claim 1, wherein the speed of shifting of said body to be cut relative to said cutting member is 10 mm/minute to 15000 mm/minute.

7. A cutting apparatus for a layered sheet, which is a cutting apparatus for cutting a cross section of a layered sheet that has been cut into rectangular form, comprising:
a clamp mechanism for fixing a body to be cut that is formed by stacking a number of layered sheets;
a cutting member having a rotational axis perpendicular to the cross sections of said body to be cut and a cutting blade that is provided so as to protrude toward the cross section side of said body to be cut;
a first drive mechanism for rotating said cutting member around said rotational axis;
a second drive mechanism for shifting said body to be cut relative to said cutting member; and
a control unit for controlling the drive functions of said first drive mechanism and said second drive mechanism.

8. A layered sheet that has been cut in accordance with the method according to claim 1.

9. The layered sheet according to claim 8, characterized in that said layered sheet is an optical member.

10. An optical element, wherein the optical member according to claim 9 is provided on one or two sides of the optical element.

11. An image display, wherein the optical member according to claim 9 is mounted.

12. An image display, wherein the optical element according to claim 10 is mounted.

13. The cutting method according to claim 2, wherein
at least a pair of cutting members, each of which is the same as said cutting member, is provided and placed at a predetermined interval so as to respectively correspond to cross sections of said body to be cut that are opposite to each other, and
said body to be cut is shifted relative to said cutting members so that said cutting blade makes contact with the respective cross sections of said body to be cut that are opposite to each other.

14. The cutting method according to claim 13, comprising after the step of cutting the cross sections of said body to be cut that are opposite to each other:
the step of shifting said cutting members in the axis direction of said rotational axis so as to be placed at a predetermined interval;
the step of rotating said body to be cut or said cutting members; and
the step of shifting said body to cut relative to said cutting members so that said cutting blades can make contact with cross sections which are perpendicular to the cross sections on which said cutting has been carried out.

15. The cutting method according to claim 2, wherein the rotational speed of said cutting member is 800 rpm to 11000 rpm.

16. The cutting method according to claim 3, wherein the rotational speed of said cutting member is 800 rpm to 11000 rpm.

17. The cutting method according to claim 4, wherein the rotational speed of said cutting member is 800 rpm to 11000 rpm.

18. The cutting method according to claim 2, wherein the speed of shifting of said body to be cut relative to said cutting member is 10 mm/minute to 15000 mm/minute.

19. The cutting method according to claim 3, wherein the speed of shifting of said body to be cut relative to said cutting member is 10 mm/minute to 15000 mm/minute.

20. The cutting method according to claim 4, wherein the speed of shifting of said body to be cut relative to said cutting member is 10 mm/minute to 15000 mm/minute.
